(19) United States
(12) Patent Application Publication
(10) Pub. No.: US 2025/0034982 A1
(43) Pub. Date: Jan. 30, 2025

(54) TRIMMING ATTACHMENT TOOL AND METHODS

(71) Applicant: SAUDI ARABIAN OIL COMPANY, Dhahran (SA)

(72) Inventor: Sameeh Issa Batarseh, Dhahran (SA)

(73) Assignee: SAUDI ARABIAN OIL COMPANY, Dhahran (SA)

(21) Appl. No.: 18/358,451

(22) Filed: Jul. 25, 2023

(51) Int. Cl. E21B 44/02; B23K 26/08; B23K 26/10; B23K 26/36; E21B 47/07

(52) U.S. Cl. CPC E21B 44/02; B23K 26/0869; B23K 26/10; B23K 26/36; E21B 47/07

(57) ABSTRACT

A tool for trimming an interior surface in a wellbore includes a jacket configured to be mounted at an external surface of a main body. The jacket includes a proximal end and a distal end, and also includes two or more mutually detachable portions. One or more fiberoptic cables extend to the distal end of the jacket and produce a ring-shaped laser beam for trimming the interior surface in the wellbore. A related method includes: mounting a jacket at an external surface of a main body, wherein the jacket includes two or more mutually detachable portions; extending one or more fiberoptic cables to a distal end of the jacket; deploying the main body and the jacket into a wellbore; via the one or more fiberoptic cables, producing a ring-shaped laser beam; and via the ring-shaped laser beam, trimming an interior surface in the wellbore.

### BACKGROUND

In the hydrocarbon recovery arts, a commonly encountered issue involves tools becoming stuck in wellbores due to foreign objects and uneven surfaces that may be present. This can occur in open holes and in cased holes alike, and may be brought about by irregular drilling, cavitation or issues related to geomechanics.

Conventionally, a mechanical trimming tool may be lowered into the wellbore to level and even out one or more interior surfaces of the cased or uncased hole, to then permit any and all tools or implements to be run downhole substantially unimpeded. However, such a trimming process can invite significant inefficiencies, and may be very costly with the time and resources expended, particularly as an active operation may need to be interrupted.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a tool for trimming an interior surface in a wellbore. The tool includes a jacket configured to be mounted at an external surface of a main body. The jacket includes a proximal end and a distal end, and also includes two or more mutually detachable portions. One or more fiberoptic cables extend to the distal end of the jacket and produce a ring-shaped laser beam for trimming the interior surface in the wellbore.

In one aspect, embodiments disclosed herein relate to a method including: mounting a jacket at an external surface of a main body, the jacket including a proximal end and a distal end, wherein the jacket includes two or more mutually detachable portions; extending one or more fiberoptic cables to the distal end of the jacket; deploying the main body and the jacket into a wellbore; via the one or more fiberoptic cables, producing a ring-shaped laser beam; and via the ring-shaped laser beam, trimming an interior surface in the wellbore.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 schematically illustrates, in a cross-sectional elevational view, a well site with a drilling rig and wellbore in accordance with one or more embodiments.

FIG. 2 schematically illustrates, in isometric view, a wellbore in which a trimming tool is disposed, in accordance with one or more embodiments.

FIGS. 3A and 3B schematically illustrate a laser trimming jacket in isometric view, respectively, in assembled and disassembled configurations.

FIG. 4 shows a flowchart of a method, in accordance with one or more embodiments.

FIG. 5 schematically illustrates a computing device and related components, in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Broadly contemplated herein, in accordance with one or more embodiments, is a trimming tool that includes a main downhole tool body with an external jacket fit thereupon. The trimming tool can also accommodate fiberoptics to perform the actual trimming or cutting via a high-powered laser, wherein a ring-shaped beam may be created downhole of the tool. By using a high-powered laser to trim and remove impeding materials in a wellbore, and with precision control availed via fiberoptics, a much more even and symmetrical hole can result in comparison with conventional mechanical devices. The external jacket, for its part, can be sized or customized to reliably fit onto different downhole tools.

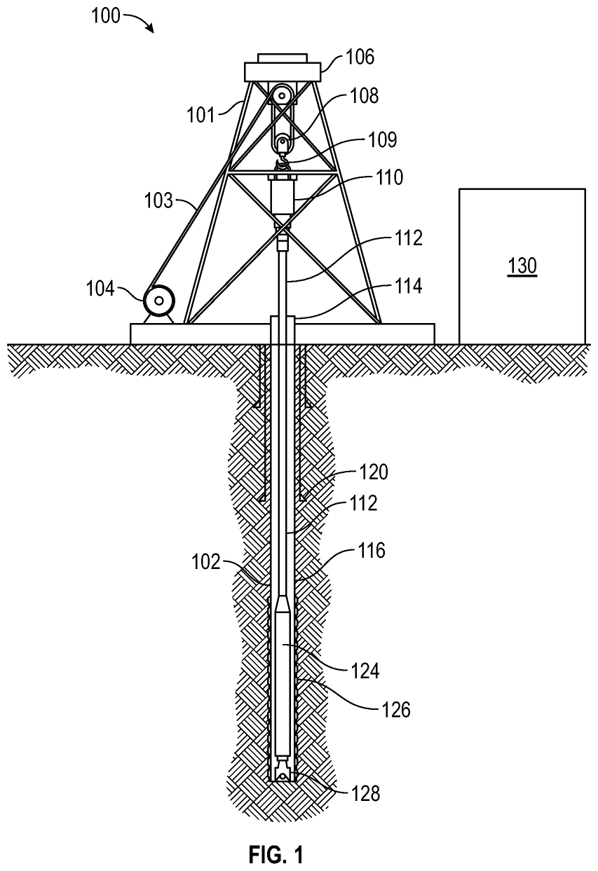

Turning now to the figures, to facilitate easier reference when describing FIGS. 1-5, reference numerals may be advanced by a multiple of 100 in indicating a similar or analogous component or element among FIGS. 1-5.

FIG. 1 schematically illustrates, in a cross-sectional elevational view, a well site with a drilling rig and wellbore in accordance with one or more embodiments. As such, FIG. 1 illustrates a non-restrictive example of a well site 100. The well site 100 is depicted as being on land. In other examples, the well site 100 may be offshore, and drilling may be carried out with or without use of a marine riser. A drilling operation at well site 100 may include drilling a wellbore 102 into a subsurface including various formations 126. More than one wellbore 102 may be included at the well site 100, but for the present purposes of illustration only one wellbore 102 is shown. For the purpose of drilling a new section of wellbore 102, a drill string 112 is suspended within the wellbore 102. The drill string 112 may include one or more drill pipes connected to form conduit and a bottom hole assembly (BHA) 124 disposed at the distal end of the conduit. The BHA 124 may include a drill bit 128 to cut into the subsurface rock. The BHA 124 may include measurement tools, such as a measurement-while-drilling (MWD) tool or a logging-while-drilling (LWD) tool (not shown), as well as other drilling tools that are not specifically shown but would be understood to a person skilled in the art.

Additionally, the drill string 112 may be suspended in wellbore 102 by a derrick structure 101. A crown block 106 may be mounted at the top of the derrick structure 101. A traveling block 108 may hang down from the crown block 106 by means of a cable or drill line 103. One end of the drill line 103 may be connected to a drawworks 104, which is a reeling device that can be used to adjust the length of the drill line 103 so that the traveling block 108 may move up or down the derrick structure 101. The traveling block 108 may include a hook 109 on which a top drive 110 is supported. The top drive 110 is coupled to the top of the drill string 112 and is operable to rotate the drill string 112. Alternatively, the drill string 112 may be rotated by means of a rotary table (not shown) on the surface 114. Drilling fluid (commonly called mud) may be pumped from a mud system 130 into the drill string 112. The mud may flow into the drill string 112 through appropriate flow paths in the top drive 110 or through a rotary swivel, if a rotary table is used (not shown).

Further, by way of general background in accordance with one or more embodiments, and during a drilling operation at the well site 100, the drill string 112 is rotated relative to the wellbore 102 and weight is applied to the drill bit 128 to enable the drill bit 128 to break rock as the drill string 112 is rotated. In some cases, the drill bit 128 may be rotated independently with a drilling motor. Generally, it is also possible to rotate the drill bit 128 using a combination of a drilling motor and the top drive 110 (or a rotary swivel if a rotary table is used instead of a top drive) to rotate the drill string 112. While cutting rock with the drill bit 128, drilling fluid or “mud” (not shown) is pumped into the drill string 112. The mud flows down the drill string 112 and exits into the bottom of the wellbore 102 through nozzles in the drill bit 128. The mud in the wellbore 102 then flows back up to the surface 114 in an annular space between the drill string 112 and the wellbore 102 carrying entrained cuttings to the surface 114. The mud with the cuttings is returned to the mud system 130 to be circulated back again into the drill string 112. Typically, the cuttings are removed from the mud, and the mud is reconditioned as necessary, before pumping the mud again into the drill string 112.

Continuing with FIG. 1, drilling operations are completed upon the retrieval of the drill string 112, the BHA 124, and the drill bit 128 from the wellbore 102. In some embodiments of wellbore 102 construction, production casing operations may commence. A casing string 116, which is made up of one or more larger diameter tubulars that have a larger inner diameter than the drill string 112 but a smaller outer diameter than the wellbore 102, is lowered into the wellbore 102 on the drill string 112. Generally, the casing string 116 is designed to isolate the internal diameter of the wellbore 102 from the adjacent formation 126. Once the casing string 116 is in position, it is set and cement is typically pumped down through the internal space of the casing string 116, out of the bottom of the casing shoe 120, and into the annular space between the wellbore 102 and the outer diameter of the casing string 116. This secures the casing string 116 in place and creates the desired isolation between the wellbore 102 and the formation 126. At this point, drilling of the next section of the wellbore 102 may commence.

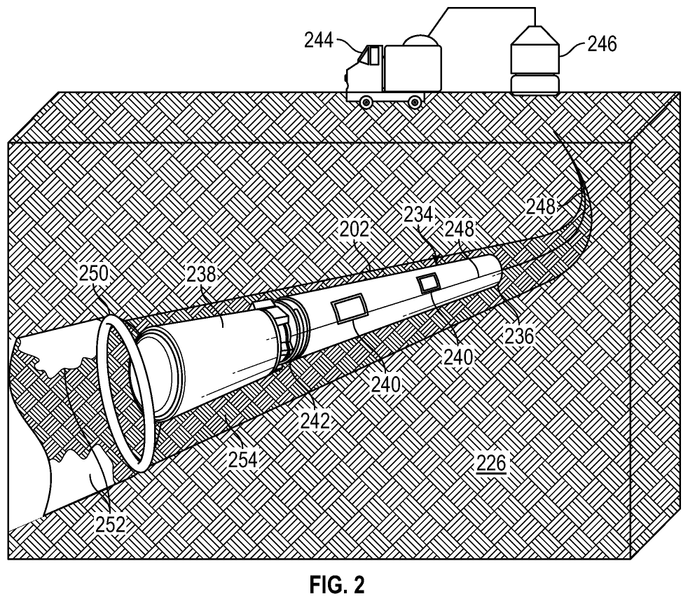

FIG. 2 schematically illustrates, in isometric view, a wellbore in which a trimming tool is disposed, in accordance with one or more embodiments. As shown, wellbore 202 is depicted as a lateral wellbore in a formation 226 (e.g., sandstone), but it should be understood that a trimming tool can be utilized in essentially any type of wellbore.

As shown, and in in accordance with one or more embodiments, a trimming tool 234 may include a main tool body 236 and a laser trimming jacket 238 disposed at an external surface of a distal end of the main body 236. The tool 234 may be deployed into a wellbore independently as shown, or may be attached to or form a portion of a BHA such as that indicated at 124 in FIG. 1.

In accordance with one or more embodiments, main body 236 includes one or more latching arrangements 240 disposed at an external surface thereof; two such latching arrangements 240 are shown in FIG. 2 and are axially spaced apart with respect to one another. The latching arrangements 240 may act to latch onto an interior surface of wellbore 202 or a casing, and thereby can fix the tool 234 at a predetermined axial position within the wellbore 202. Further, a centralizer 242 may be provided to center the tool 234 radially within the wellbore 202. Here, centralizer 242 is disposed axially adjacent to a proximal end of laser trimming jacket 238, but essentially can be disposed at any suitable axial location along tool 234.

In accordance with one or more embodiments, though a wide variety of implementations are possible, latching arrangements 240 may include essentially any suitable mechanical implement that can expand or extend and then latch onto or affix to the interior surface of wellbore 202 or a casing. For instance, the latching arrangements 240 may each include a pad or plate that presents a high coefficient of friction with the interior surface of wellbore 202 or a casing, and that is mounted on an arm that generally extends in a radially outward direction from the laser trimming jacket 238 to bring the pad or plate into contact with the interior surface of wellbore 202 or a casing. For its part, the centralizer 242 may be embodied as generally known in the hydrocarbon recovery arts for centering a casing prior to cementing. Thus, merely by way of illustrative and non-restrictive example, the centralizer 242 may include a hinged collar and bow springs that ensure a radially centered placement of the laser trimming jacket within the wellbore 202, via mutual contact of one or more elements of the centralizer 242 and the interior surface of wellbore 202 or a casing.

In accordance with one or more embodiments, a high-power laser source 244 may be located at a terrestrial surface, e.g., on a truck as shown. In operation, once the tool 234 is latched and centered within wellbore 202, laser energy generated by the source 244 may be routed through a control unit 246 and conveyed via one or more fiberoptic cables 248 to tool 234 and trimming jacket 238. Trimming jacket 238, installed (e.g., affixed or clipped) onto the main tool body 236 prior to deploying the tool 234 downhole, then acts to produce a ring-shaped laser beam 250. Control unit 246, for its part, may be embodied by a physical location (e.g., a small building or other structure) that contains one or more automatic or manual mechanisms for controlling the admission of laser energy through fiberoptic cables 248 and for controlling one or more other mechanisms as described herein. Control unit 246 thus may include one or more processors or user interfaces in communication with one or more computers housed therein or located remotely, such as the computer 582 described and illustrated with respect to FIG. 5.

In accordance with one or more embodiments, essentially any suitable laser source 244 may be employed for the purposes at hand. By way of illustrative and non-restrictive example, a truck-mounted laser source 244 may have a maximum power of 10.2 kilowatts, while each fiberoptic cable 248 may have a core diameter of about 300 micrometers. A beam produced by source 244 and transmitted by cables 248 may be multimode-diode pumped, with a beam parameter product (BPP) of about 14 mm×mrad (millimeters times milliradians) and a wavelength of about 1070 nm (nanometers).

As such, and in accordance with one or more embodiments, the beam 250 may be projected ahead of the distal end of tool 234, thus in a downhole direction, to permit removal of irregularities 252 disposed at or on an uneven surface in the wellbore 202. The beam 250 may assume any predetermined diameter with respect to the wellbore 202, as may be desired for the task at hand. If the tool 234 is then moved further forward downhole, the beam 250 will continue to remove irregularities from the internal surface of the wellbore or casing toward the continued creation of a trimmed (or “even”) hole 254.

In accordance with one or more embodiments, in one possible mode of operation, the beam 250 may be controlled in a manner to translate a given distance downhole even while the tool 234 is fixed and centered within the hole. In another possible mode of operation, the beam 250 may be controlled to remain in a fixed axial position with respect to the tool 234 while the entire tool 234 is deployed downhole at a predetermined rate. Thus, the two modes of operation may act separately or together to effect relative translational displacement of the beam 250 with respect to the wellbore 202 at one or more different rates as may be desired. Related control may be effected at or via the control unit 246, which itself may contain or be in communication with a computer such as that indicated at 582 in FIG. 5.

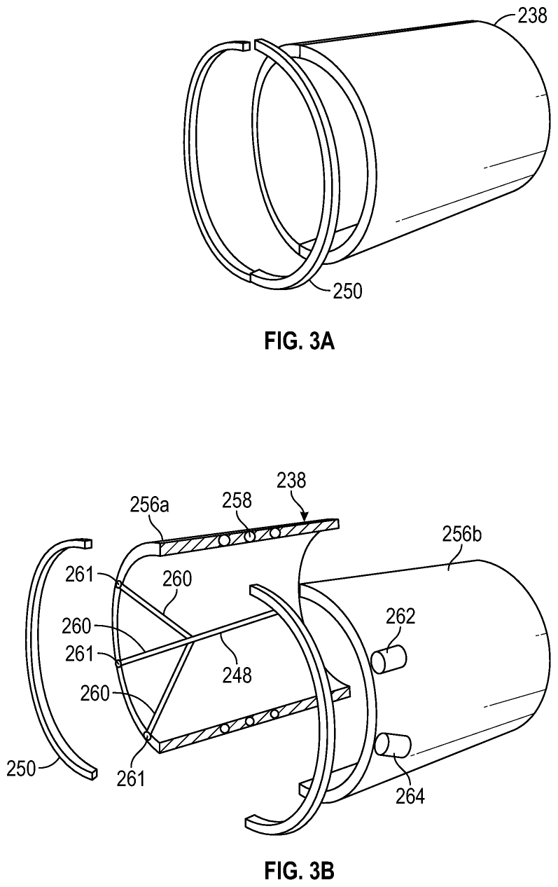

In accordance with one or more embodiments, FIGS. 3A and 3B schematically illustrate the laser trimming jacket 238 in isometric view, respectively, in assembled and disassembled configurations. Reference can continue to be made to both figures.

In accordance with one or more embodiments, laser trimming jacket 238 may be formed from two or more partial tubular portions. Thus, in the present working example, two half-tubular portions 256a and 256b are shown. Each partial tubular portion 256a/b can include a set of magnets 258 embedded at each of two terminal circumferential ends of each partial tubular portion 256a/b. Thus, the magnets 258 interact to facilitate affixing the partial tubular portions 256a/b to one another to form a full tubular shape for the laser trimming jacket 238. Instead of or in addition to magnets 258, alternatives such as clips or straps may be used.

In accordance with one or more embodiments, as seen in FIG. 3B, the one or more fiberoptic cables 248 may enter through a proximal (uphole) end of the jacket 238 and then split, as shown, into a plurality of branch cables 260 that run toward the distal (downhole) end of the jacket. Each of the branch cables 260 extends to a corresponding terminal end 261, from which an individual laser beam is projected. While three branch cables 260 are shown, it should be understood that they may be provided or configured in essentially any suitable number and arrangement to form the ring-shaped laser beam 250. Branch cables 260 may each be directed via one or more suitable apertures to a position corresponding to a terminal end 261 at an external surface of jacket 238 or, alternatively, each terminal end 261 may be embedded in the jacket 238 and exposed at an annular end surface of the jacket 238. Though not specifically illustrated in FIG. 3B, an annular connector element may be affixed to the annular end surface of the jacket 238 to accommodate the terminal ends 261 of branch cables 260, and may be configured to permit each terminal end 261 to emit an individual beam toward forming the ring-shaped beam 250. The number of branch cables 260 may suitably be selected for the application at hand, but generally it should be appreciated and understood that a higher powered beam originating from source 244 (see FIG. 2) may translate to a need for fewer branch cables 260, while a lower powered originating beam may warrant a higher number of branch cables 260.

In accordance with one or more embodiments, one or more temperature sensors 262 may be provided to measure a current temperature at one or more locations of the trimming tool (see 234 in FIG. 2) and in the wellbore. Thus, a suitable feedback and shutdown mechanism may be employed to deactivate the laser beam when one or more temperatures are sensed above a predetermined threshold in the wellbore or tool (e.g., within the jacket 238 or main body 236 shown in FIG. 2). Such a feedback and shutdown mechanism may be incorporated into the control unit 246, which itself may contain or be connected to a computer such as that indicated at 582 in FIG. 5. Communication between the one or more temperature sensors 262 and control unit 246 may be effected via a wired or wireless connection.

In accordance with one or more embodiments, one or more acoustic cameras 264 may be provided to capture and transmit visual images from the distal (downhole) end of the tool, to visualize a “target” or other objects or impediments downhole and to help track distance and velocity while the tool is moving downhole. Communication between the one or more acoustic cameras 264 and control unit 246 may be effected via a wired or wireless connection.

In accordance with one or more embodiments, the one or more temperature sensors 262 and one or more acoustic cameras 264 may be mounted essentially at any suitable location. In the working example illustrated, one sensor 262 and one camera 264 are mounted at an external surface of a distal end of the laser trimming jacket 238.

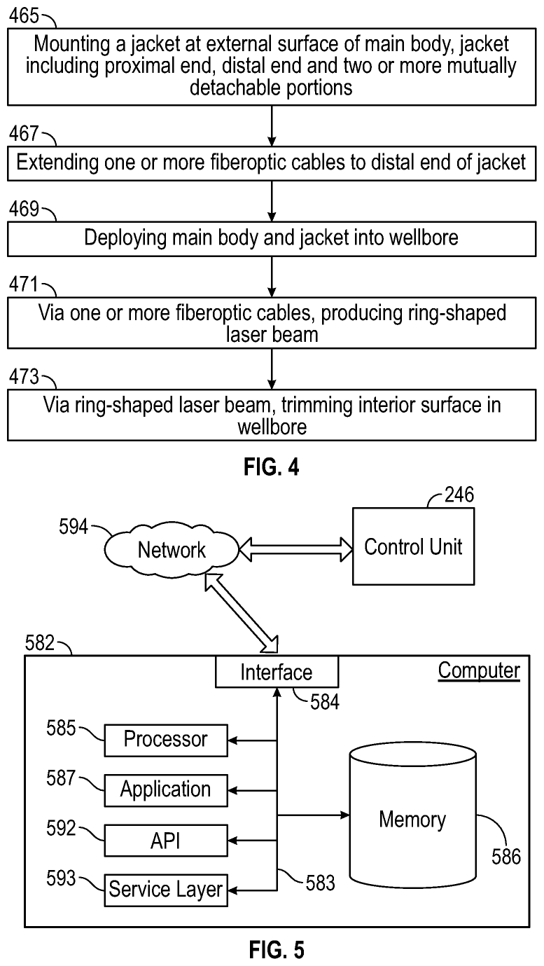

FIG. 4 shows a flowchart of a method, as a general overview of steps which may be carried out in accordance with one or more embodiments described or contemplated herein. Specifically, FIG. 4 describes a method of trimming an interior surface in a wellbore. One or more blocks in FIG. 4 may be performed using one or more components as described in FIGS. 1-3 and 5. While the various blocks in FIG. 4 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

As such, in accordance with one or more embodiments, a jacket is mounted at an external surface of a main body, the jacket including a proximal end and a distal end, wherein the jacket includes two or more mutually detachable portions (465). By way of illustrative example, this may correspond to the jacket 238, portions 25a/b and main body 236 described and illustrated with respect to FIGS. 2-3B. One or more fiberoptic cables are extended to the distal end of the jacket (467). By way of illustrative example, this may correspond to the one or more cables 248 and branch cables 260 described and illustrated with respect to FIGS. 2 and 3B. The main body and the jacket are deployed into a wellbore (469). Via the one or more fiberoptic cables, a ring-shaped laser beam is produced (471) and, via the ring-shaped laser beam, an interior surface in the wellbore is trimmed (473). By way of illustrative example, these steps may be appreciated in connection with the process described and illustrated with respect to FIGS. 2-3B.

FIG. 5 schematically illustrates a computing device and related components, in accordance with one or more embodiments. As such, FIG. 5 generally depicts a block diagram of a computer system 582 used to provide computational functionalities associated with described algorithms, methods, functions, processes, flows, and procedures as described in this disclosure, according to one or more embodiments. In this respect, computer 582 may be utilized in communication with one or more components of a control unit, such as that (246) described and illustrated with respect to FIG. 2, either locally or remotely via an internal or external network 594.

In accordance with one or more embodiments, the illustrated computer 582 is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer 582 may include a computer that includes an input device, such as a keypad, keyboard, touch screen, or other device that can accept user information, and an output device that conveys information associated with the operation of the computer 582, including digital data, visual, or audio information (or a combination of information), or a GUI.

The computer 582 can serve in a role as a client, network component, a server, a database or other persistency, or any other component (or a combination of roles) of a computer system for performing the subject matter described in the instant disclosure. The illustrated computer 582 is communicably coupled with a network 594. In some implementations, one or more components of the computer 582 may be configured to operate within environments, including cloud-computing-based, local, global, or other environment (or a combination of environments).

At a high level, the computer 582 is an electronic computing device operable to receive, transmit, process, store, or manage data and information associated with the described subject matter. According to some implementations, the computer 582 may also include or be communicably coupled with an application server, e-mail server, web server, caching server, streaming data server, business intelligence (BI) server, or other server (or a combination of servers).

The computer 582 can receive requests over network 594 from a client application (for example, executing on another computer 582) and responding to the received requests by processing the said requests in an appropriate software application. In addition, requests may also be sent to the computer 582 from internal users (for example, from a command console or by other appropriate access method), external or third-parties, other automated applications, as well as any other appropriate entities, individuals, systems, or computers.

Each of the components of the computer 582 can communicate using a system bus 583. In some implementations, any or all of the components of the computer 582, both hardware or software (or a combination of hardware and software), may interface with each other or the interface 584 (or a combination of both) over the system bus 583 using an application programming interface (API) 592 or a service layer 593 (or a combination of the API 592 and service layer 593. The API 592 may include specifications for routines, data structures, and object classes. The API 592 may be either computer-language independent or dependent and refer to a complete interface, a single function, or even a set of APIs. The service layer 593 provides software services to the computer 582 or other components (whether or not illustrated) that are communicably coupled to the computer 582. The functionality of the computer 582 may be accessible for all service consumers using this service layer. Software services, such as those provided by the service layer 593, provide reusable, defined business functionalities through a defined interface. For example, the interface may be software written in JAVA. C++, or other suitable language providing data in extensible markup language (XML) format or another suitable format. While illustrated as an integrated component of the computer 582, alternative implementations may illustrate the API 592 or the service layer 593 as stand-alone components in relation to other components of the computer 582 or other components (whether or not illustrated) that are communicably coupled to the computer 582. Moreover, any or all parts of the API 592 or the service layer 593 may be implemented as child or sub-modules of another software module, enterprise application, or hardware module without departing from the scope of this disclosure.

The computer 582 includes an interface 584. Although illustrated as a single interface 584 in FIG. 5, two or more interfaces 584 may be used according to particular needs, desires, or particular implementations of the computer 582. The interface 584 is used by the computer 582 for communicating with other systems in a distributed environment that are connected to the network 594. Generally, the interface 584 includes logic encoded in software or hardware (or a combination of software and hardware) and operable to communicate with the network 594. More specifically, the interface 584 may include software supporting one or more communication protocols associated with communications such that the network 594 or interface's hardware is operable to communicate physical signals within and outside of the illustrated computer 582.

The computer 582 includes at least one computer processor 585. Although illustrated as a single computer processor 585 in FIG. 5, two or more processors may be used according to particular needs, desires, or particular implementations of the computer 582. Generally, the computer processor 585 executes instructions and manipulates data to perform the operations of the computer 582 and any algorithms, methods, functions, processes, flows, and procedures as described in the instant disclosure.

The computer 582 also includes a memory 586 that holds data for the computer 582 or other components (or a combination of both) that can be connected to the network 594. For example, memory 586 can be a database storing data consistent with this disclosure. Although illustrated as a single memory 586 in FIG. 5, two or more memories may be used according to particular needs, desires, or particular implementations of the computer 582 and the described functionality. While memory 586 is illustrated as an integral component of the computer 582, in alternative implementations, memory 586 can be external to the computer 582.

The application 587 is an algorithmic software engine providing functionality according to particular needs, desires, or particular implementations of the computer 582, particularly with respect to functionality described in this disclosure. For example, application 587 can serve as one or more components, modules, applications, etc. Further, although illustrated as a single application 587, the application 587 may be implemented as multiple applications 587 on the computer 582. In addition, although illustrated as integral to the computer 582, in alternative implementations, the application 587 can be external to the computer 582.

There may be any number of computers 582 associated with, or external to, a computer system containing computer 582, wherein each computer 582 communicates over network 594. Further, the term “client,” “user,” and other appropriate terminology may be used interchangeably as appropriate without departing from the scope of this disclosure. Moreover, this disclosure contemplates that many users may use one computer 582, or that one user may use multiple computers 582.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A tool for trimming an interior surface in a wellbore, the tool comprising:
a jacket configured to be mounted at an external surface of a main body, the jacket including a proximal end and a distal end;
the jacket including two or more mutually detachable portions; and
one or more fiberoptic cables that extend to the distal end of the jacket and produce a ring-shaped laser beam for trimming the interior surface in the wellbore.

2. The tool according to claim 1, wherein the two or more mutually detachable portions comprise two or more partial tubular portions.

3. The tool according to claim 2, wherein the two or more partial tubular portions are two partial tubular portions.

4. The tool according to claim 3, further comprising magnets that affix the two partial tubular portions to one another.

5. The tool according to claim 4, wherein:
each of the two partial tubular portions includes two terminal circumferential ends; and
the magnets are embedded at each of the two terminal circumferential ends of each of the two partial tubular portions.

6. The tool according to claim 1, wherein the one or more fiberoptic cables extend from a laser source to the proximal end of the jacket and split into a plurality of branch cables that extend to the distal end of the jacket and that combine to project the ring-shaped laser beam in a downhole direction from the distal end of the jacket.

7. The tool according to claim 1, further comprising a control unit that controls the ring-shaped laser beam to translate downhole from the distal end of the jacket when the tool is in a fixed position.

8. The tool according to claim 1, further comprising one or more temperature sensors mounted on the jacket.

9. The tool according to claim 8, further comprising a control unit that deactivates the ring-shaped laser beam when the one or more temperature sensors sense a temperature in the tool or in the wellbore above a predetermined threshold.

10. The tool according to claim 1, further comprising one or more acoustic cameras mounted on the jacket.

11. The tool according to claim 1, further comprising one or more latching arrangements configured to latch onto the interior surface in the wellbore.

12. The tool according to claim 1, further comprising a centralizer configured to center the tool radially within the wellbore.

13. A method comprising:
mounting a jacket at an external surface of a main body, the jacket including a proximal end and a distal end, wherein the jacket includes two or more mutually detachable portions;
extending one or more fiberoptic cables to the distal end of the jacket;
deploying the main body and the jacket into a wellbore;
via the one or more fiberoptic cables, producing a ring-shaped laser beam; and
via the ring-shaped laser beam, trimming an interior surface in the wellbore.

14. The method according to claim 13, wherein mounting the jacket comprises attaching the two or more mutually detachable portions to one another.

15. The method according to claim 14, wherein the two or more mutually detachable portions comprise two partial tubular portions.

16. The method according to claim 15, wherein the attaching comprises affixing the two partial tubular portions to one another via magnets.

17. The method according to claim 13, wherein the one or more fiberoptic cables extend from a laser source to the proximal end of the jacket and split into a plurality of branch cables that extend to the distal end of the jacket and that combine to project the ring-shaped laser beam in a downhole direction from the distal end of the jacket.

18. The method according to claim 13, further comprising controlling the ring-shaped laser beam to translate downhole from the distal end of the jacket when the jacket and the main body are in a fixed position in the wellbore.

19. The method according to claim 13, further comprising:
mounting one or more temperature sensors on the jacket; and
deactivating the ring-shaped laser beam when the one or more temperature sensors sense a temperature in the jacket, main body or wellbore above a predetermined threshold.

20. The method according to claim 13, further comprising mounting one or more acoustic cameras on the jacket.
